(19) United States
(12) Patent Application Publication
(10) Pub. No.: US 2024/0249645 A1
(43) Pub. Date: Jul. 25, 2024

(54) SURGICAL TRAINING DEVICE

(71) Applicant: Connor Hoyle, Rockford, MI (US)

(72) Inventor: Connor Hoyle, Rockford, MI (US)

(21) Appl. No.: 18/417,157

(22) Filed: Jan. 19, 2024

Related U.S. Application Data
(60) Provisional application No. 63/481,085, filed on Jan. 23, 2023.

(51) Int. Cl. G09B 23/30; B29C 64/386; B33Y 10/00; B33Y 50/02; B33Y 80/00; G09B 23/34; B29K 67/00; B29L 31/00

(52) U.S. Cl. CPC G09B 23/303; B29C 64/386; B33Y 10/00; B33Y 50/02; B33Y 80/00; G09B 23/34; B29K 2067/003; B29K 2067/046; B29L 2031/753

(57) ABSTRACT

An artificial or simulated skull for use as a medical training device includes a skull cap that can be secured to a skull base at an opening defined by the skull base. One or more vessels for holding fluid, such as simulated blood, may be secured or incorporated into the simulated skull. A trainee, such as a medical student, may perform a practice procedure on the simulated skull, such as a drilling procedure in which the trainee uses a surgical tool to create one or more burr holes in the skull cap before penetrating the vessel containing the simulated blood. Once the skull cap has been excessively damaged from use in one or more practice procedures, it may be replaced with a new skull cap that can be secured to the original skull base.

### CROSS REFERENCE TO RELATED APPLICATION

The present application claims the benefit of U.S. provisional application Ser. No. 63/481,085, filed Jan. 23, 2023, which is hereby incorporated herein by reference in its entirety.

### FIELD OF THE INVENTION

The present invention relates to a modeled or simulated skull that can be used as a medical or surgical training device.

### BACKGROUND OF THE INVENTION

Various medical procedures performed by a medical professional require numerous hours of training before the medical professional may perform the procedure on a patient. Training for various medical procedures often involves performing a simulated procedure on artificial or simulated human body parts. Certain medical procedures that involve cutting or drilling, for example, may damage or destroy the simulated human body part, such that a new simulated body part is required before the procedure can be practiced again.

### SUMMARY OF THE INVENTION

The surgical training device of the present invention is adapted to mimic a human skull, and may be used for practicing various surgical procedures. One such procedure involves drilling a burr hole into a skull to remove/release blood from within the skull. Such a procedure could be performed on a human patient, for example, due to internal bleeding caused from a head injury. The training device includes an artificial or simulated skull having a skull base with an opening, and a skull portion in the form of a cap that can be secured to the skull base at the skull opening. One or more vessels holding a fluid, such as simulated blood, may be secured within the simulated skull at a preferred location where it is desired to simulate excess or undesired blood from an internal bleed, for example. A trainee may use a surgical tool such as a drill to create a burr hole through the skull cap and into the vessel. Fluid from the vessel may escape from the burr hole to provide a visual indication that the simulated blood was successfully accessed. After one or more training procedures of this sort are performed, the skull cap and/or the vessel may be substituted with a new replacement skull cap and/or vessel, thus preserving the skull base for repeated use.

According to one form of the invention, an artificial or simulated skull for use as a surgical training device includes a skull base defining a skull opening, and a skull portion in the form of a cap or closure that is configured to be releasably coupled to the skull base at the skull opening such that the skull cap and the skull base collectively define an internal skull cavity. A vessel for holding a fluid is securable to the skull cap within the skull cavity, and the skull cap and the vessel are configured to be penetrated by a drilling tool.

In one aspect, the vessel further includes an inlet port configured to receive the fluid into the vessel. Optionally, the inlet port includes a self-closing membrane.

In another aspect, the skull cap and the vessel are configured to discharge the fluid when the skull cap and the vessel are penetrated by the drilling tool.

In yet another aspect, the skull cap is coupled to the skull base via a press-fit connection. Optionally, projections are located at the skull base and/or the skull cap, and receiving holes are located at the skull base and/or the skull cap. The receiving holes are configured to receive the projections to couple the skull cap to the skull base. The skull cap may be located at an upper portion of the simulated skull.

In still another aspect, the vessel is selectively securable to the skull cap. Alternatively, the vessel is unitarily formed with the skull cap. Optionally, the skull cap includes six of the vessels, where three of the vessels are located at a lateral side of the skull cap and three of the vessels are located at an opposing lateral side of the skull cap.

In a further aspect, the simulated skull includes an outer layer of simulated skin covering at least a portion of the skull cap.

In yet a further aspect, the skull cap is made up of a plurality of laminated or deposited plastic layers. Optionally, the skull base is made up of a plurality of laminated or deposited plastic layers.

According to a method of the present invention for manufacturing a simulated skull for use in surgical training, the method includes: providing a computer with three-dimensional (3D) modeling data including layer-by-layer data of a skull base having a skull opening, and layer-by-layer data of a skull cap having a shape and size that corresponds to the skull opening; and executing a 3D printing operation to create the skull base and the skull cap using a 3D printer, in which the computer transmits the 3D modeling data to the 3D printer, the 3D printer deposits a plurality of layers based on the layer-by-layer data of the skull base to physically form the skull base, and the 3D printer deposits a plurality of layers based on the layer-by-layer data of the skull cap to physically form the skull cap that is a separate component from the skull base. The skull cap is positionable at the skull opening such that the skull cap and the skull base collectively form the simulated skull and define an internal skull cavity.

In one aspect, the 3D modeling data further includes layer-by-layer data representing a vessel for holding a fluid. The 3D printer deposits a plurality of layers based on the layer-by-layer data of the vessel to unitarily form the vessel with the skull cap. Alternatively, the 3D modeling data further includes layer-by-layer data representing a vessel for holding a fluid, where the 3D printer deposits a plurality of layers based on the layer-by-layer data of the vessel to physically form the vessel as a separate component from the skull cap such that the vessel is selectively securable to the skull cap within the skull cavity.

In another aspect, the 3D modeling data further includes layer-by-layer data representing press-fit projections and receiving holes. The 3D printer laminates a plurality of layers based on the layer-by-layer data of the press-fit projections and the receiving holes to unitarily form the projections at either the skull base and/or the skull cap, and to unitarily form the receiving holes at either the skull base and/or the skull cap. The skull cap is securable to the skull base at the skull opening by inserting the press-fit projections into the receiving holes.

According to another form of the present invention, a simulated skull for use as a surgical training device includes a skull base defining a skull opening, and skull cap configured to be coupled at the skull opening such that the skull cap and the skull base collectively define an enclosed skull cavity. An outer layer of simulated skin covers at least a portion of the skull cap, and a vessel for holding a fluid is securable to the skull cap within the skull cavity. The vessel includes an inlet port configured to receive the fluid into the vessel. The skull cap and the vessel are configured to be penetrated by a drilling tool such that, once penetrated, fluid will discharge out from the skull cap and the vessel.

In one aspect, the inlet port includes a self-closing membrane.

In another aspect, projections are located at the skull base and/or the skull cap, and receiving holes are located at the skull base and/or the skull cap. The receiving holes are configured to receive the projections to couple the skull cap to the skull base.

Thus, the surgical training device of the present invention enables a person, such as a medical student or medical professional, to use a simulated skull to practice various medical procedures involving cutting, drilling, or otherwise removing or relocating bodily material and/or fluid, while minimizing the time, cost, and waste associated with the replacing the simulated skull or components thereof. An artificial or simulated skull includes a skull base with an opening at which a skull cap may be secured to define a skull cavity. A vessel containing fluid that may mimic blood, for example, can be secured within the skull cavity. A medical trainee may then use the simulated skull for practicing a medical procedure, in which the trainee penetrates the skull cap and the vessel with a surgical tool. If the trainee penetrated the simulated skull at the correct location, the fluid will become visible to the trainee where the skull cap was penetrated. The skull cap and the vessel are replaceable, such as when one or more procedures have been performed, in which new skull caps and vessels may be secured to the same skull base.

These and other objects, advantages, purposes and features of the present invention will become apparent upon review of the following specification in conjunction with the drawings.

### BRIEF DESCRIPTION OF THE DRAWINGS

FIG. 1 is a perspective view of a simulated skull for surgical training in accordance with the present invention, in which a hole is being drilled into the simulated skull during a training procedure;

FIG. 2 is another perspective view of the simulated skull of FIG. 1;

FIG. 3 is a lower perspective view of a skull cap of the simulated skull of FIG. 1;

FIG. 4 is a rear perspective view of a skull base of the simulated skull of FIG. 1;

FIG. 5 a perspective view of a skull cap that has been used for a surgical training procedure; and

FIGS. 6 and 7 are sectional views of a skull cap portion and blood well during a drilling procedure in accordance with the present invention.

### DETAILED DESCRIPTION OF THE PREFERRED EMBODIMENTS

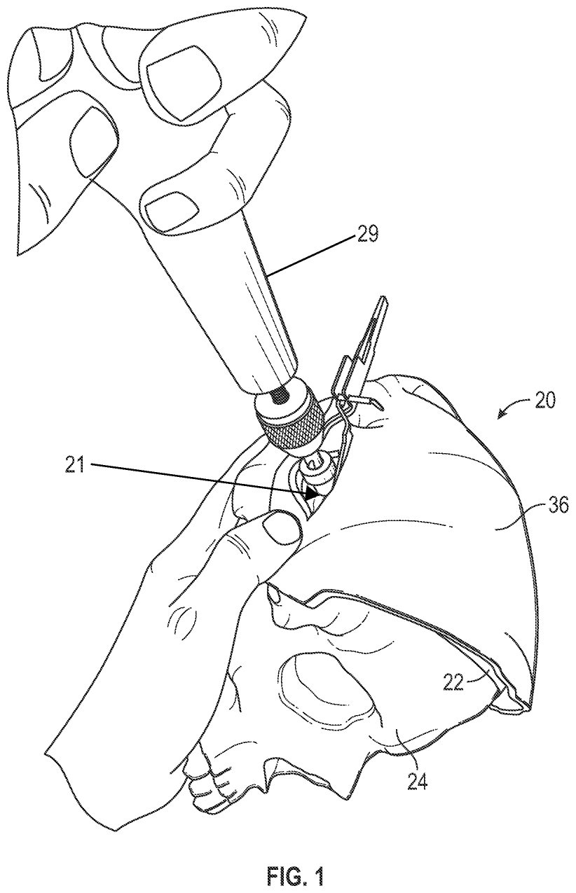

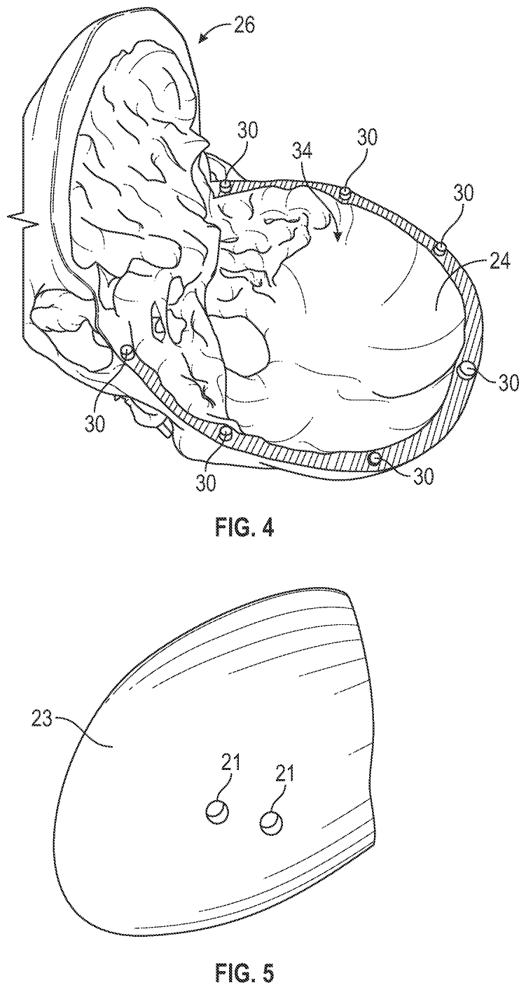

Referring now to the drawings and the illustrative embodiments depicted therein, a skull structure or model in the form of a simulated or artificial skull 20 facilitates practicing various medical procedures, including procedures that require damaging or destroying portions of artificial skull 20 such as by drilling one or more burr holes 21 into skull 20 (FIGS. 1 and 5). A replaceable and/or disposable skull portion, such as a skull cap 22 is secured to a skull base 24 at a skull opening 26 defined by skull base 24 (FIGS. 3 and 4). A fluid vessel or container in the form of a blood well 28 is affixed to or incorporated into skull 20, and holds a fluid such as simulated blood, so that when a cutting tool or drilling tool 29 penetrates the skull cap 22 in the location of the blood well 28, at an angle such that the tool 29 directly enters the blood well 28 where the skull cap 22 was fully penetrated, some of the fluid will exit the blood well 28 through the burr hole 21 or other opening that was formed by the tool 29. This provides visual confirmation that the opening was formed in the desired location, while also presenting a somewhat realistic simulation of the fluid that would be expected to exit an opening formed in an actual medical patient's skull during an actual medical procedure.

Skull 20 is a multipart object resembling a human skull, and includes replaceable or disposable portions that are attachable to one or more reusable portions. Skull base 24 is a reusable portion of skull 20, and represents a lower portion of a human skull (FIGS. 1, 2, and 4). Skull cap 22 is securable to skull base 24 such that the position of skull cap 22 is at and/or proximate an upper portion of skull 20. The upper portion of skull 20, when considered relative to the locations of bones in a typical human skull, includes or encompasses at least portions of the left and right parietal bones, the frontal bone, and/or the left and right temporal bones, for example.

As noted, skull cap 22 is a temporary or replaceable portion of skull 20, and is shaped and sized to correspond to the shape and size of opening 26 (FIG. 3). Skull cap 22 is positionable and/or securable to skull base 24 at opening 26 at or near the upper portion of skull 20 via one or more press-fit pins or projections positioned at or defined by skull base 24 that frictionally engage receiving holes 32 defined by skull cap 22. However, it should be understood that press-fit pins or projections could be located at skull cap 22 while receiving holes could be defined by skull base 24, or projections and holes may be in an alternating arrangement. Additionally, other securing features may be used to position and secure a skull cap to a skull base, such as magnets, snaps, hook-and-loop fasteners, and the like.

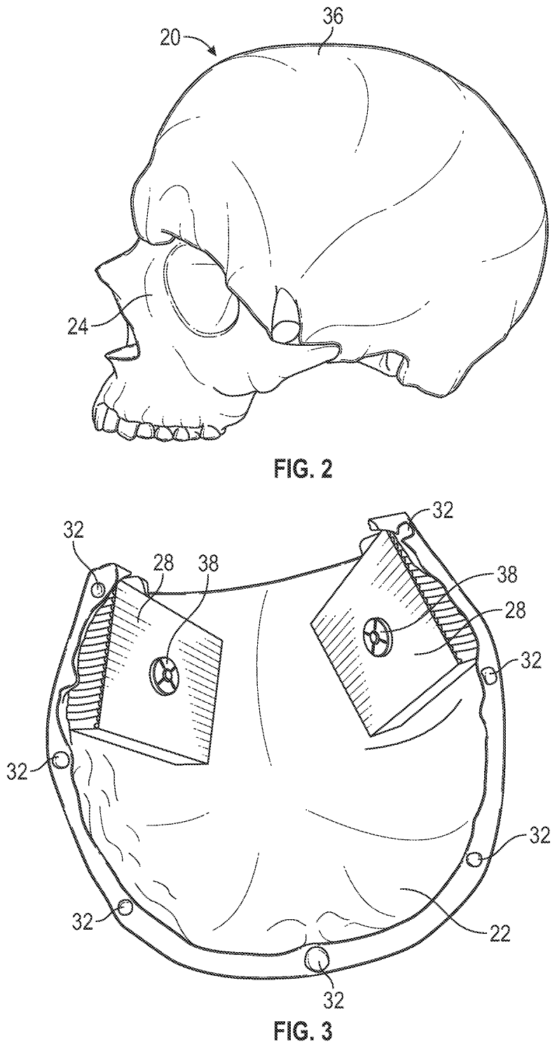

Once secured to skull base 24, skull cap 22 substantially overlies and/or covers opening 26, such that skull base 24 and skull cap 22 collectively define an internal volume or skull cavity 34. For added realism, a simulated or artificial skin layer 36 may be coupled to or overlaid or applied onto portions or the entirety of the exterior of skull cap 22 and/or skull base 24. (FIGS. 1 and 2). It should be appreciated that the shape and size of the skull base, skull opening, and/or skull cap may vary within the scope of the present invention, and that a simulated skull may include multiple openings at which multiple skull caps may be positioned and secured. Furthermore, the location of one or more openings for accommodating a replaceable skull cap may vary without departing from the present invention.

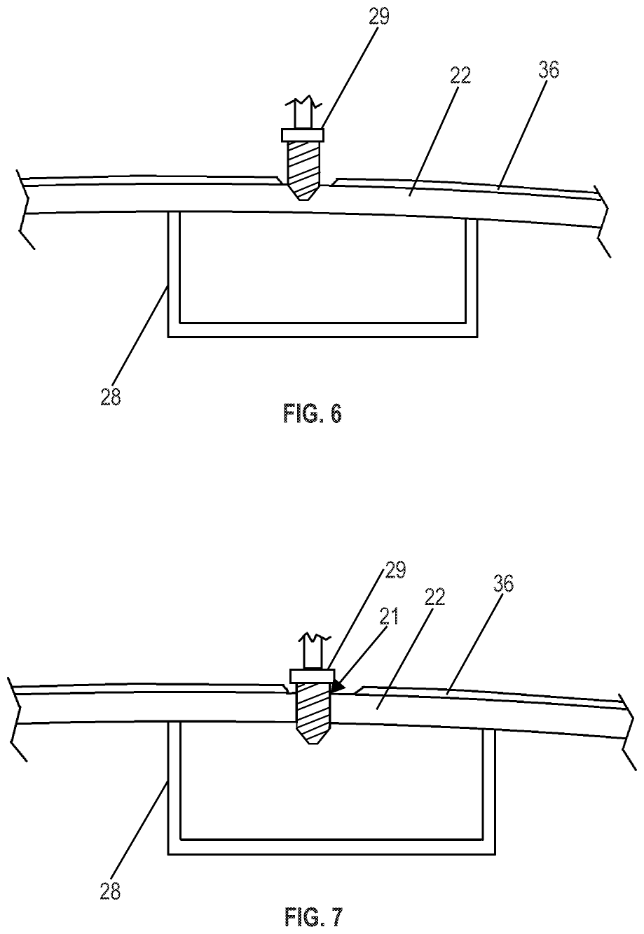

With reference to FIG. 3, blood well 28 contains a fluid such as simulated blood, and includes an inlet port 38 through which a user may add fluid into blood well 28. In the illustrated embodiment, blood well 28 is scalable to hold a fluid within its interior until it is penetrated by surgical tool 29, such as shown in FIGS. 6 and 7. Additionally, prior to being penetrated, blood well 28 may maintain a fluid pressure within its interior that is higher than atmospheric pressure, or main contain a fluid-containing bladder with elastic walls that can hold the fluid under pressure above atmospheric. Although a blood well inlet may take many forms, in the illustrated embodiment, inlet 38 is a self-healing or self-closing syringe membrane through which a syringe needle may be inserted to inject fluid into blood well 28. After the needle is removed from blood well 28, the inlet's flexible and/or resilient nature causes inlet 38 to automatically close to enable blood well 28 to securely contain fluid. It should be appreciated that an inlet port may vary the scope of the present invention, and could take alternative forms such as a hole or threaded hole configured to receive a plug or threaded insert, for example.

Blood wells 28 may be integrally formed with skull cap 22 as a unitary body, or as a separate component that is selectively attachable or securable to skull cap 22. In the illustrated embodiment, blood well 28 is made of a rigid material, such as the same plastic or thermoplastic material that forms skull cap 22, and is integrally formed with the skull cap 22. Optionally, a blood well may be formed from a less rigid material such as an elastic material, or may be in the form of a pouch formed of flexible and/or clastic material. In the case of a pouch or pouch-like blood well, the pouch may have an adhesive surface, snaps, magnets, hook-and-loop fasteners, or the like for attaching it to a desired location along the interior of skull cap 22. A blood well may also be secured in place using a strap that is anchored along the interior of skull cap 22.

Optionally, blood well 28 may have elastic walls or an elastic button-like insert so that the fluid may be contained at higher than atmospheric pressure, which facilitates seepage of the fluid through one of the burr holes 21. With reference again to FIG. 3, a pair of blood wells 28 are shown secured to an interior portion of skull cap 22 at different locations. To provide added realism to a practice procedure performed on skull 20, once blood wells 28 are secured to skull cap 22, the location of blood wells 28 will not be discernible to a trainee when skull cap 22 is secured to skull base 24. Blood wells 28 may be positioned and secured to skull cap 22 or embedded and/or incorporated into skull cap 22 at various locations in which it is desired to simulate blood or cranial fluids that must be accessed during a medical procedure. For example, during a drilling procedure, such as the procedure described in more detail below, common drilling locations into a human skull may include temporal and frontal locations on each side of the skull. Therefore, it may be desirable to place or incorporate blood wells 28 at one or more of these locations, or other locations where it is common to drill into a human skull. Optionally, additional blood wells 28 may be secured to the interior of skull cap 22, such as three blood wells 28 located along each lateral side of skull cap 22 for a total of six. It should be understood that blood wells 28 could additionally or alternatively be located at or in skull base 24 such that a trainee would be expected to drill through skull base 24, or potentially at an oblique angle through skull cap 22, or anywhere within skull cavity 34.

The trainee or user may use skull 20 to practice various medical procedures. For example, a practice or simulated drilling procedure could mimic a real world medical scenario in which it is necessary to relieve pressure exerted on a patient's brain due to internal bleeding by drilling one or more burr holes through the patient's skull in order to access and drain/remove blood located within or proximate their skull cavity or head. In the practice drilling procedure, the trainee may use a surgical tool, such as tool 29, to drill through one or more locations of skull cap 22 in order to access blood wells 28. As noted above, blood wells 28 may be used to simulate locations within a patient where excess or undesired blood needs to be accessed and drained or otherwise removed. If the trainee drills through skull cap 22 at the correct location and at an appropriate angle for direct penetration of the blood well through skull cap 22, the trainee may visually perceive fluid exiting bore hole 21 in skull cap 22, thus indicating that blood well 28 was successfully accessed during the practice procedure.

Practice procedures may be repeated by the trainee as many times as desired, or until a point where skull cap 22 and/or the one or more blood wells 28 affixed or incorporated into skull cap 22 are too damaged or depleted to repeat the procedure in a desired fashion. For example, as shown in FIG. 5, two burr holes 21 were drilled into a used skull cap 23 such that the realism or practicality of performing yet another practice drilling procedure using used skull cap 23 is diminished. At this point, used skull cap 23 may be removed from skull base 24 and disposed of, or potentially a new blood well may be positioned along the interior of the used skull cap 23. A replacement skull cap, such as unused skull cap 22 (FIG. 3) that may be substantially identical to used skull cap 23, may be secured to skull base 24 at opening 26 in a similar fashion as previously described, at which point practice procedures may once again be performed.

It should be appreciated that a replacement skull cap could vary from a previously disposed-of or used skull cap. For example, a replacement skull cap could be thicker, thinner, made of a different material, or have other features or characteristics that vary from the previous skull cap that was attached to a skull base. Additionally, blood wells associated with the replacement skull cap may vary from the previously-used blood wells. For example, new blood wells could contain more or less fluid, could be located at alternative positions at or within a skull cap, could be made of a different material, or may be shaped and sized differently.

The various components of skull 20 may be manufactured in numerous ways including, for example, via a three-dimensional (3D) printing method. In this method of manufacturing skull 20, a computer may be provided with 3D modeling data that represents skull 20. The modeling data may be based at least in part on existing data related to human skulls, including data from one or more computerized tomography (CT) scans, and/or data related to various dimensions of human skulls such as average widths of the inner and outer tables (sides or surfaces) of human skulls. Thus, skull cap 22 and/or skull base 24 could be modeled after the actual anatomical shape of an individual patient's skull, optionally including a blood well 28 at the actual location of fluid inside the patient's skull, and used for visualization and practice prior to the actual medical procedure. The data may take the form of layer-by-layer data of skull base 24, including skull opening 26, and layer-by-layer data of skull cap 22, in which skull cap 22 may have a shape and size that generally corresponds to skull opening 26, and may also include cavities and/or pockets that form blood wells 28, or at which blood wells 28 may be positioned or secured.

A 3D printing operation may then be executed via a 3D printer to create skull 20. During the printing operation, the computer transmits the 3D modeling data to the 3D printer, and the 3D printer prints and/or laminates or deposits numerous layers based on the layer-by-layer data discussed above to form skull cap 22 and skull base 24. Once the printing operation is completed, skull cap 22 may be positioned and/or secured to skull base 24 at skull opening 26. Additionally, press-fit pins 30 and/or receiving holes 32 may be formed into skull cap 22 and skull base 24 during the printing process to facilitate the ability to secure skull cap 22 to skull base 24. Alternatively, press-fit pins 30 may be manufactured out of a metallic material via a machining process, for example, turning brass material on a lathe to create a cylindrical shape.

Blood wells 28 may be 3D-printed into skull cap 22 and/or skull base 24, or 3D-printed as separate components that are secured to skull cap 22 and/or skull base 24. Inlets 38 may be placed, secured, or incorporated into blood wells 28, such as after blood wells 28 are incorporated into or secured to skull cap 22 and/or skull base 24. As previously noted, blood wells 28 may be filled with fluid, for example, via injecting a fluid into blood wells 28 using a syringe as previously discussed. Skin layer 36 may also be added to the exterior surface of skull 20. For example, a liquid silicone material that can cure and/or harden may be added to the exterior of skull 20 by pouring the liquid silicone over skull 20 or by dipping skull 20 into a container of liquid silicone. The materials used in the 3D printing process to create simulated skull 20 may vary, and could include various plastic and/or thermoplastic materials, such as polyethylene terephthalate glycol (PETG) or polylactic acid (PLA).

Accordingly, the surgical training device of the present invention provides an effective way to repeatedly practice a medical procedure, such as a drilling procedure, while minimizing the waste and cost associated with replacing and disposing of components damaged from the procedure. A simulated skull includes a replaceable skull cap that is attachable to a skull base at an opening defined by the skull base. One or more blood wells are located at or within the skull cap or skull base to simulate blood within a patient's head. A trainee may use a surgical tool to penetrate the skull cap and access fluid contained within the blood wells. Fluid from the blood well may exit the skull cap if the trainee penetrated the skull cap at the correct location and at the correct angle. The used/damaged skull cap may be replaced with a new skull cap as desired, in which the new skull cap may be attached to the same skull base.

Changes and modifications in the specifically described embodiments may be carried out without departing from the principles of the present invention, which is intended to be limited only by the scope of the appended claims, as interpreted according to the principles of patent law including the doctrine of equivalents.

The embodiments of the invention in which an exclusive property or privilege is claimed are defined as follows:

1. A simulated skull for use as a surgical training device, said simulated skull comprising:
a skull base defining a skull opening;
a skull cap configured to be releasably coupled to said skull base at said skull opening such that said skull cap and said skull base collectively define an internal skull cavity; and
a vessel for holding a fluid and configured to be secured to said skull cap within said skull cavity;
wherein said skull cap and said vessel are configured to be penetrated by a drilling tool.

2. The simulated skull of claim 1, wherein said vessel further comprises an inlet port configured to receive the fluid into said vessel.

3. The simulated skull of claim 2, wherein said inlet port comprises a self-closing membrane.

4. The simulated skull of claim 3, wherein said skull cap and said vessel are configured to discharge the fluid when said skull cap and said vessel are penetrated by the drilling tool.

5. The simulated skull of claim 1, wherein said skull cap is coupled to said skull base via a press-fit connection.

6. The simulated skull of claim 5, further comprising projections located at said skull base and/or said skull cap, and receiving holes located at said skull base and/or said skull cap, wherein said receiving holes are configured to receive said projections to couple said skull cap to said skull base.

7. The simulated skull of claim 6, wherein said skull cap is at an upper portion of said simulated skull.

8. The simulated skull of claim 1, wherein said vessel is selectively securable to said skull cap.

9. The simulated skull of claim 1, wherein said vessel is unitarily formed with said skull cap.

10. The simulated skull of claim 1, comprising three of said vessels at a lateral side of said skull cap, and three of said vessels at an opposing lateral side of said skull cap.

11. The simulated skull of claim 1, wherein said simulated skull further comprises an outer layer of simulated skin covering at least a portion of said skull cap.

12. The simulated skull of claim 1, wherein said skull cap comprises a plurality of deposited plastic layers.

13. The simulated skull of claim 1, wherein said skull base comprises a plurality of deposited plastic layers.

14. A simulated skull for use as a surgical training device, said simulated skull comprising:
a skull base defining a skull opening;
a skull cap configured to be coupled to said skull base at said skull opening such that said skull cap and said skull base collectively define an internal skull cavity;
a vessel coupled to an interior surface of said skull cap and configured to contain a fluid; and
an outer layer of simulated skin covering at least a portion of said skull portion;
wherein said skull cap and said vessel are configured to be penetrated by a drilling tool; and
wherein said skull cap and said vessel are configured to discharge the fluid when said skull cap and said vessel are penetrated by the drilling tool.

15. The simulated skull of claim 14, wherein said vessel comprises an inlet port having a self-closing membrane.

16. The simulated skull of claim 15, further comprising projections located at said skull base and/or said skull cap, and receiving holes located at said skull base and/or said skull cap, and wherein said receiving holes are configured to receive said projections to couple said skull cap to said skull base.

17. A method for manufacturing a simulated skull for use in surgical training, said method comprising:
providing a computer with three-dimensional (3D) modeling data comprising layer-by-layer data of a skull base having a skull opening, and layer-by-layer data of a skull cap having a shape and size that corresponds to the skull opening; and
executing a 3D printing operation to create the skull base and the skull cap using a 3D printer, wherein the computer transmits the 3D modeling data to the 3D printer, wherein said 3D printer deposits a plurality of layers based on the layer-by-layer data of the skull base to physically form the skull base, and wherein the 3D printer deposits a plurality of layers based on the layer-by-layer data of the skull cap to physically form the skull cap that is a separate component from said skull base;
wherein the skull cap is positionable at the skull opening such that the skull cap and the skull base collectively form the simulated skull and define an internal skull cavity.

18. The method of claim 17, wherein the 3D modeling data further comprises layer-by-layer data representing a vessel for holding a fluid, wherein the 3D printer deposits a plurality of layers based on the layer-by-layer data of the vessel to unitarily form the vessel with the skull cap.

19. The method of claim 17, wherein the 3D modeling data further comprises layer-by-layer data representing a vessel for holding a fluid, wherein the 3D printer deposits a plurality of layers based on the layer-by-layer data of the vessel to physically form the vessel as a separate component from the skull cap, and wherein the vessel is selectively securable to the skull cap within the skull cavity.

20. The method of claim 17, wherein the 3D modeling data further comprises layer-by-layer data representing press-fit projections and receiving holes, wherein the 3D printer deposits a plurality of layers based on the layer-by-layer data of the press-fit projections and the receiving holes to unitarily form the projections at either the skull base and/or the skull cap, and to unitarily form the receiving holes at either the skull base and/or the skull cap, and wherein the skull cap is securable to the skull base at the skull opening by inserting the press-fit projections into the receiving holes.
